(19) United States
(12) Patent Application Publication
(10) Pub. No.: US 2009/0135959 A1
(43) Pub. Date: May 28, 2009

(54) APPARATUS AND METHOD FOR DETECTING A MISSING PULSE IN COMPLEMENTARY CODED IRREGULAR SIGNALS

(75) Inventors: Boris Iordanov, Newmarket (CA); Michael Sacson, Richmond Hill (CA)

Correspondence Address: LOWE HAUPTMAN HAM & BERNER, LLP, 1700 DIAGONAL ROAD, SUITE 300, ALEXANDRIA, VA, 22314, US

(73) Assignee: Thales Rail Signalling Solutions Inc., Weston (CA)

(21) Appl. No.: 11/945,784

(22) Filed: Nov. 27, 2007

(51) Int. Cl. H04L 27/06

(52) U.S. Cl. 375/340

(57) ABSTRACT

An apparatus and method for decoding complementary coded irregular data streams including a missing pulse detector circuit. The missing pulse detector circuit includes electrical circuit components configured to receive first and second irregular data streams, and output a data stream corresponding to a valid input data stream only when the two received data streams are bit-for-bit complements of each other.

### FIELD OF THE INVENTION

The present invention relates generally to data transmission circuits, and more specifically, circuit arrangements for detecting missing pulses in complementary coded irregular data streams.

### BACKGROUND OF THE INVENTION

Missing pulse detectors utilizing retriggerable monostable flip-flops offer the ability to detect a missing pulse in data streams of regular and constant frequency. Detecting these missing pulses is made more difficult in high frequency FSK (frequency shift keying) systems comprising data streams of irregular signals, such as used when transmitting digital telegrams.

Digital telegrams are used, for example, in frequency-variable automatic train stop systems (ATS) that communicate between ground stations and a moving train, wherein an onboard device performs train control based on a frequency variable signal from a ground unit.

### SUMMARY OF THE INVENTION

Under certain circumstances, data may be corrupted during transmission. Although some systems may incorporate apparatus to recover data from the corrupted data stream, the present embodiments include apparatus and methods for decoding irregular data streams in high speed data applications. Once detected, retransmission of the data may be requested.

One aspect of an apparatus and method of decoding data in an irregular data stream, comprises receiving a first irregular digital data stream and a second irregular digital data stream and outputting a digital data stream corresponding to one of the first and second digital data streams only if the first and second digital data streams are bit-for-bit complements of each other.

Another aspect includes a missing pulse detector circuit further embodied by a multiplexer configured to receive first and second irregular data streams wherein the data streams are complementary, i.e., logically inverted, and a flip-flop is interconnected with the multiplexer, wherein the arrangement of the multiplexer and the flip-flop detects a missing bit in one of the two complementary and irregular data streams.

A further aspect includes a data transmission method that includes a transmitter that generates a second digital data stream that is a logical complement of a first digital data stream. The first and second digital data streams are then transmitted through a transmission medium, that non-limiting, includes one or more of wireless and cable media, wherein the cable may be electrical or optically conducting. An interface device operates to convert a digital data stream to whatever stream of modulated energy required by the transmission medium. On the receiving side, an interface device receives the transmitted data streams and outputs the received data streams to a missing pulse detector that generates an output data stream based upon the received data streams, if the received data streams are bit-for-bit complements of each other.

### BRIEF DESCRIPTION OF THE DRAWINGS

The present apparatus and methods are illustrated by way of example, and not by limitation, in the figures of the accompanying drawings, wherein elements having the same reference numeral designations represent like elements throughout and wherein:

FIG. 1 is a system diagram of a communication system that includes a missing pulse detector, according to the present invention;

FIG. 2 illustrates an exemplary circuit diagram of a missing pulse detector circuit, according to the system of FIG. 1; and

FIG. 3 is a timing diagram of one embodiment of a missing pulse detector, according to the circuit diagram of FIG. 2; and

FIG. 4 is flowchart of one embodiment of a data transmission system, according to the system diagram of FIG. 1.

### DETAILED DESCRIPTION OF THE EXEMPLARY EMBODIMENTS

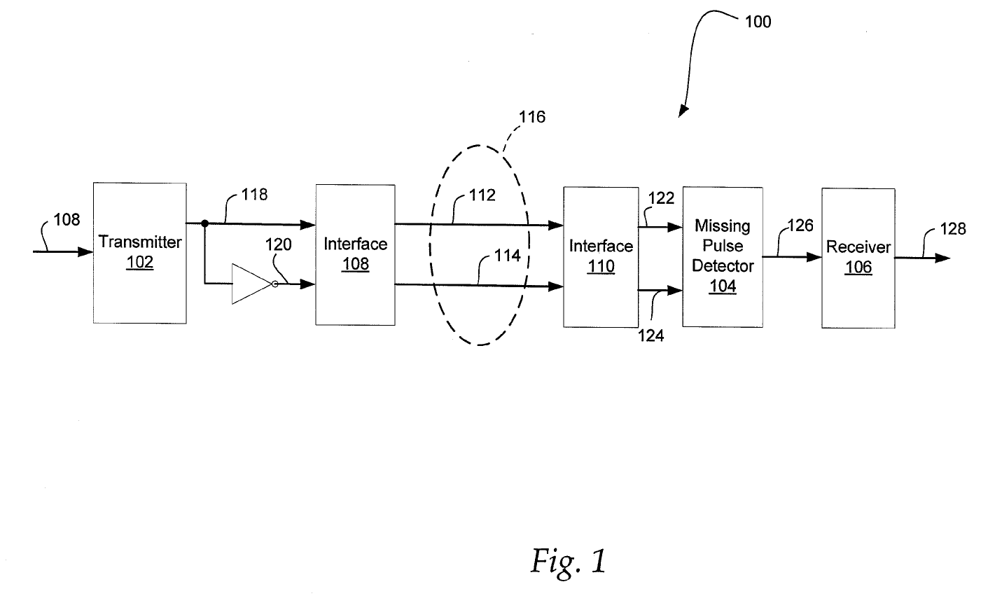

FIG. 1 illustrates a block diagram of a communications system 100 that includes a missing pulse detector 104 on a receive side of the communications system 100. As illustrated in FIG. 1, transmitter 102 receives a data stream 108 to be transmitted over medium 116 to a receiver 106. The output of transmitter 102 is received by interface 108 and includes a first non-inverted data stream 118 and a complementary data stream 120 that is the logical inverse of data stream 118. In one embodiment, interface 108 is an electrical to optical converter operable to transmit data over optical medium 116. In other embodiments, interface 108 comprises balanced line drivers to drive balanced electrical signals over an electrical conducting medium.

The receiver portion of communication system 100 includes receive interface 110 that receives non-inverting and inverting data streams 112, 114, respectively, and outputs data streams 122 and 124. In the absence of transmission or hardware errors, digital data streams 122 and 124 are complementary signals, wherein at any given instant, data stream 122 is at a logical one level when data stream 124 is at a logical zero level.

Unlike other transmission systems that restores missing data as long as either data present in data streams 122 or 124 is correct, missing pulse detector 104 only outputs a valid output 126 as long as signals 122 and 124 are bit-for-bit complements of each other. Output data stream 126 is fed into receiver 106. Receiver 106 is paired with transmitter 102, such that the transmitted protocol is decoded by receiver 106, and the payload of data stream 128 corresponds to input data stream 108.

Communication system 100 illustrates a one-way communication path. Non-limiting, full duplex communications may be implemented by implementing the components of system 100 in the backward direction.

Missing pulse detector 104 includes circuit arrangements for detecting irregularity in any one of complementary signals 112 and 114, or a failure in the detecting logic itself.

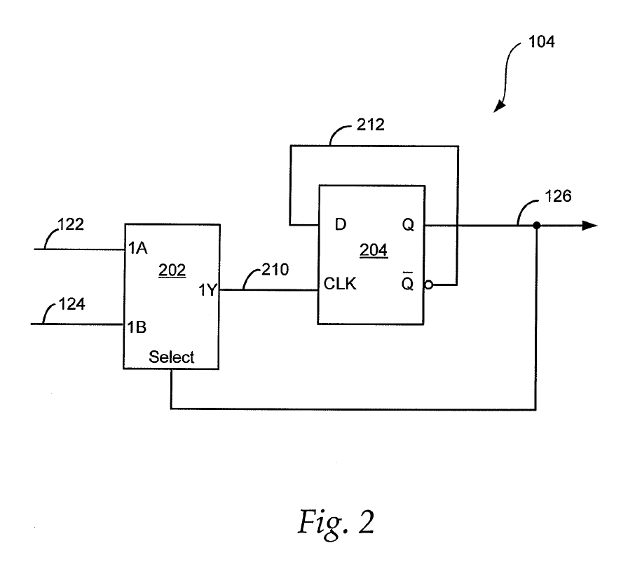

FIG. 2 illustrates one embodiment of missing pulse detector 104 implemented using a multiplexer 202 and an edge-triggered D flip-flop 204. In other embodiments, the circuit illustrated in FIG. 2 may be implemented using other circuit elements known to those of ordinary skill in circuit design, i.e., a programmable logic array (PLA), a J-K flip-flop or other logic components that, unlike software implementations, allows detector 104 to detect errors in high speed data applications.

As illustrated in FIG. 2, non-inverting signal 122 and inverting signal 124 are respectively tied to inputs 1A and 1B of multiplexer 202. Signal 210 on output pin 1Y of multiplexer 202, is tied to the CLK pin of D flip-flop 204. A rising edge of signal 210 clocks in signal 212 presented at the D input of D flip-flop 204, signal 212 being tied to the inverting output of D flip-flop 204. Output data stream 126 is taken from the Q output of D flip-flop 204 and is also presented to the Select input of multiplexer 202. As disclosed below, as long as signal 124 is an exact inverse of signal 122, output signal 126 tracks signal 122, D flip-flop 204 outputting a logical one on the rising edge of signal 122, and D flip-flop 204 outputting a logical zero on the rising edge of complementary signal 124.

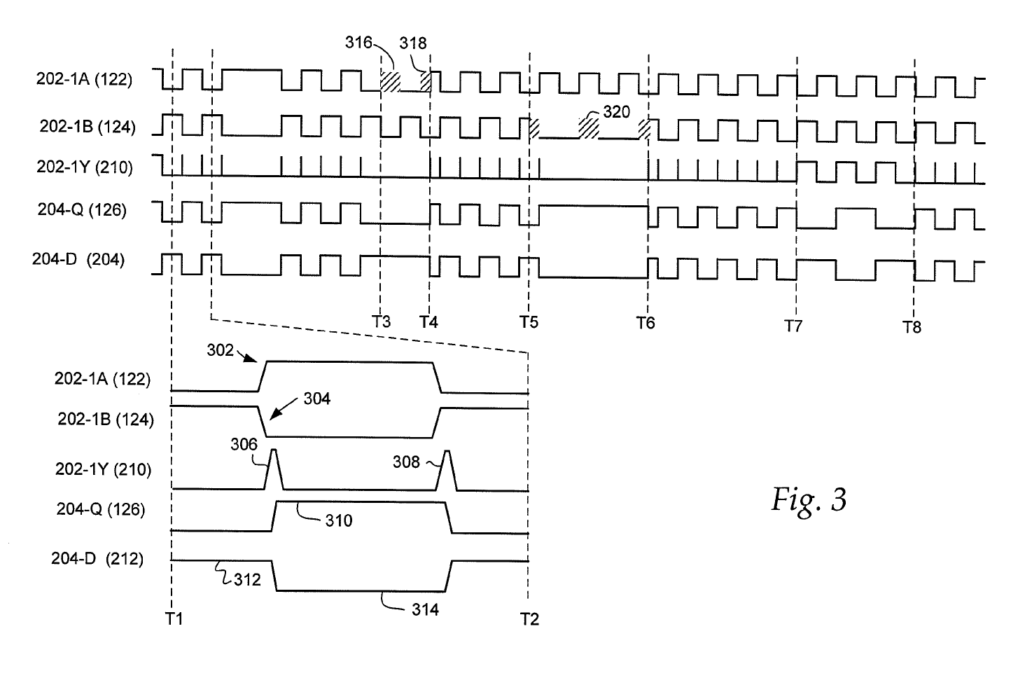

FIG. 3 is a timing diagram illustrating various waveforms of the circuit diagram illustrated in FIG. 2, based upon data signals 122 and 124. The enlarged portion of the timing chart illustrates normal operation of the circuit between times T1 and T2, when signals 122 and 124 are bit-for-bit complementary. Logical one data bit 302 of signal 122 and logical zero data bit 304 of signal 124 corresponds to complementary data streams of transmitted signal 108. Rising edge 306 corresponds to signal 210 on output 1Y of multiplexer 202 and operates to clock the logical one state, i.e., level 312, of signal 212 presented on the data input pin (204-D) of D flip-flop 204, generating the logical one state 310 on output 204-Q of D flip-flop 204 which in addition to serving as an input to receiver 106, is tied to the select pin of multiplexer 202.

A logical one level on the select pin of multiplexer 202 allows signal 124 to propagate through multiplexer 202, presenting a logic zero on the CLK pin of D flip-flop 204. When the logical states of signals 122 and 124 invert, that is, signal 122 goes low and signal 124 goes high, output 1Y of multiplexer 202 transitions to a high, logical one state. The rising edge 308 of signal 210 clocks the logical zero level 314 of signal 212 through to the output of D flip-flop 204.

Missing pulse detector 104 operates to detect irregularities between complementary signals 122 and 124. For example, at time T3, a failure in transmission medium bit 116 cause bit 312 to be dropped (indicated by shading) from signal 122. As a result, although signal 124 is still valid, there is no rising edge on signal 210 to clock D flip-flop 204, and therefore output signal 126 generates an invalid output signal. At time T4, signal 122 returns, and output 126 resumes the correct signal.

Similarly, between T5 and T6, signal 124 locks low resulting in missing bit 320. Because both signals 122 and 124 are necessary to generate a valid output signal 126, output signal 126 is held in a logical one state until signal 124 resumes at T6.

Another possible error condition is illustrated occurring between T7 and T8. In this scenario, the select pin of multiplexer 202 fails, causing output 210 of multiplexer 202 to follow signal 124, regardless of signal 126. Even though signals 122 and 124 are complementary, because of the hardware fault, the data on signal 122 is not output to data stream 126.

Based upon the embodiments disclosed above, the use of complementary signals and missing pulse detector 104 provides a level of confidence that a received data stream is not corrupted. Accordingly, as long as signals 122 and 124 are not identically corrupted, missing pulse detector can detect a missing pulse in high speed irregular data streams such as used in digital telegrams.

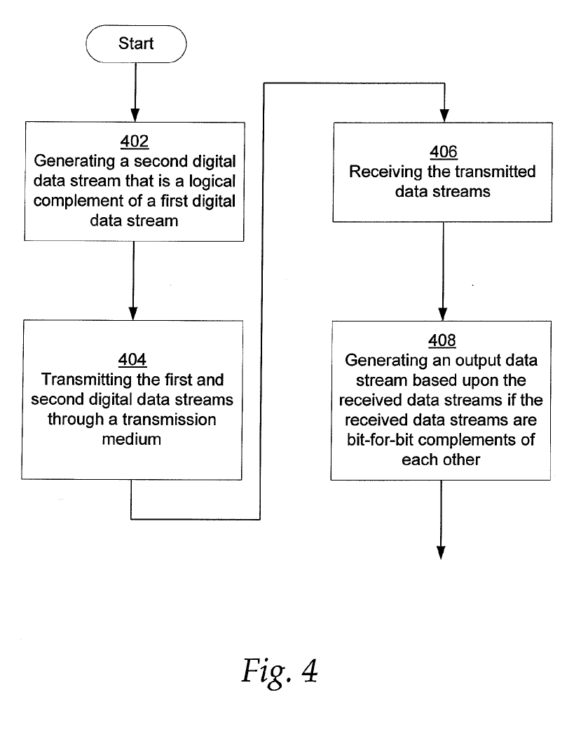

The flowchart of FIG. 4 illustrates a high-level embodiment of the method of transmitting data as disclosed herein. At 402, the method includes a transmitter 102 that generates a second digital data stream 120 that is a logical complement of a first digital data stream 118.

At 404, the first and second digital data streams 118, 120 are transmitted through transmission medium 116. Non-limiting, transmission medium 116 is wireless or cable, wherein the cable may be electrical or optically conducting. Interface device 108 operates to convert a digital data stream to whatever stream of modulated energy required by transmission medium 116.

At 406, interface 110 receives the transmitted data streams 112, 114.

At 408, missing pulse detector 104 generates an output data stream based upon the received data streams 112, 114 if the received data streams are bit-for-bit complements of each other.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

While the foregoing disclosure shows illustrative aspects and/or aspects, it should be noted that various changes and modifications could be made herein without departing from the scope of the described aspects and/or aspects as defined by the appended claims. Furthermore, although elements of the described aspects s described or claimed in the singular, the plural is contemplated unless limitation to the singular is explicitly stated. Additionally, all or a portion of any aspect and/or aspects may be utilized with all or a portion of any other aspect and/or aspect, unless stated otherwise.

What is claimed is:

1. A method of decoding data in an irregular data stream, comprising:
receiving a first irregular digital data stream and a second irregular digital data stream; and
outputting a digital data stream corresponding to one of the first and second digital data streams only if the first and second digital data streams are bit-for-bit complements of each other.

2. The method of claim 1 wherein outputting a digital stream further comprises:
generating a clock signal based upon an output of a multiplexer selecting one of the first and second digital data streams;
clocking a flip flop with the generated clock signal, an inverted output of the flip flop tied to the data-in pin of the flip flop, and a non-inverting output of the flip flop selecting which of the first and second digital data streams forms the output of the multiplexer.

3. The method of claim 2 wherein the flip flop is a D-type flip flop clocked by a rising edge of a bit in the first digital data stream when the output of the D-type flip flop is a logical zero, and is clocked by a rising edge of a bit in the second digital data stream when the output of the D-type flip flop is a logical one.

4. A data transmission method, comprising:
generating a second digital data stream that is a logical complement of a first digital data stream;
transmitting the first and second digital data streams through a transmission medium;
receiving the transmitted data streams; and
generating an output data stream based upon the received data streams if the received data streams are bit-for-bit complements of each other.

5. The method according to claim 4, wherein generating the output data stream includes:
generating a clock signal based upon an output of a multiplexer that selects one of the received data streams; and
clocking a flip-flop with the generated clock signal, the flip-flop having a data-in input tied to an inverted output of the flip flop, a non-inverting output of the flip flop selecting which of the received streams is output from the multiplexer.

6. A device for decoding irregular data streams comprises a missing pulse detector circuit for irregular signals, the missing pulse detector circuit includes:
a multiplexer configured to receive first and second irregular data streams wherein the data streams are complementary; and
a flip-flop interconnected with the multiplexer, the flip-flop arranged to detect a missing bit in one of the two complementary and irregular data streams.

7. The missing pulse detector according to claim 6:
wherein the multiplexer includes a first input configured to receive the first digital data stream and a second input configured to receive a second digital data stream, an output of the multiplexer selected by a signal applied to a select input of the multiplexer; and
wherein the flip-flop is an edge-triggered flip flop, the flip-flop further comprising:
a clock signal tied to a selected output of the multiplexer;
a data input tied to an inverting output of the flip-flop; and
a non-inverting output tied to the select input of the multiplexer; and
wherein the non-inverting output of the flip-flop follows the first irregular data stream as long as the first and second data streams are complementary to each other.

8. An irregular data stream transmission system, comprising:
a transmitter configured to generate an inverting and non-inverting data stream; and
a missing pulse detector according to claim 6.
